(19) United States
(12) Patent Application Publication
(10) Pub. No.: US 2008/0154702 A1
(43) Pub. Date: Jun. 26, 2008

(54) Method for Improving Cash Flow and Directing Buying Decisions Through the Use of Prepaid Merchant Cards

(76) Inventor: David Pleban, Boca Raton, FL (US)

Correspondence Address: ROBERT M. SCHWARTZ, P.A., P.O. BOX 221470, HOLLYWOOD, FL, 33022, US

(21) Appl. No.: 11/953,926

(22) Filed: Dec. 11, 2007

Related U.S. Application Data
(60) Provisional application No. 60/869,617, filed on Dec. 12, 2006.

(51) Int. Cl. G06Q 30/00; G06F 17/00

(52) U.S. Cl. 705/10; 705/14

(57) ABSTRACT

The present invention is a method for improving cash flow and directing customer buying decisions through the use of prepaid merchant cards providing specific discounts and promotions.

### INDEX TO RELATED APPLICATIONS

This application claims the benefit of U.S. Provisional Patent Application Ser. No. 60/869,617 filed Dec. 12, 2006 the disclosure of which is incorporated herein by reference in its entirety.

### BACKGROUND OF THE INVENTION

The invention relates to a method for using prepaid merchant cards in combination with promotions to improve the cash flow of the merchant and to enable the merchant to influence the buying decisions of his customer.

The invention is a method of utilizing prepaid merchant cards in a novel way. Prepaid merchant cards, often referred to as “Gift Cards”, have gained enormous acceptance over the last 10 years. The cards are important to merchants because of the cash flow they generate. They are important to the customer because of the convenience they provide.

The majority of prepaid merchant cards are purchased and given away as gifts. The value of the card is a function of what the buyer of the card feels is the appropriate gift for the particular occasion. That is the way they are most often marketed and the way they are most often used by the consumer or purchaser of the card.

The invention creates a new target audience for the gift cards; the consumer himself. Consumers currently do not buy the Cards for themselves as there is no reason to do so. In fact, they would be foolish to do so. However, if the consumer could gain an economic advantage by buying the Cards they would buy them for themselves. The invention provides a method for doing so. As compared with the current method for marketing prepaid gift cards, the invention will increase the number of Cards sold, the average dollar amount of each Card sold will likely be higher and the average time it takes for the Card to be redeemed will likely be longer; three highly desirable features for the merchant. In addition, the invention provides the merchant with an additional tool for directing customer buying decisions.

Briefly, a merchant would offer prepaid cards for his business. Then the merchant creates promotions on items or services that are only available to holders of prepaid cards for his business. This creates the economic incentive to buy the Card. For example, a customer buys a $50.00 prepaid merchant card from a retailer. A week later the merchant offers a 10% discount on woman's apparel to holders of a prepaid card. If the customer utilizes the card to purchase a qualified promotional item she would derive up to $55.00 of value from her $50.00 Card. Since most merchants change their promotions on a regular basis the customer will likely wait to redeem the card if he feels a better promotion is forthcoming; after all, the card was purchased to take advantage of promotions. In addition, if the merchant is one that the customer visits frequently the customer may buy a higher value Card because he views it as a safe bet. Lastly, the Card holder would have the option of using the stored value of the Card toward the purchase of non-promotional items that are purchased at the same time promotional items are being purchased. Many customers will not chose this option and hold onto the Card in hopes or redeeming it for a promotional item; thereby extending the cash flow advantage for the merchant.

To summarize the advantages to the merchant; more cards will be purchased because there is an economic reason for the consumer to buy one for himself. The consumer may buy higher value cards, especially from merchants he frequents regularly, and as compared to traditional gift cards, the consumer will likely take longer to redeem the cards as he waits for more interesting promotions.

Note that if governing laws allow the merchant to capture the stored value of a Card after a certain time frame this invention has even greater value to the merchant.

### SUMMARY OF THE INVENTION

In a preferred embodiment, the present invention is a method for improving the cash flow of a merchant and directing customer buying decisions comprising the steps of:
(a) providing a customer with a prepaid merchant card;
(b) providing information to a database about discounts and promotions available to users of said prepaid merchant card;
(c) providing a customer access to said information about discounts and promotions available to users of said prepaid merchant card.

In one embodiment, the method provides a prompt to a customer at check out regarding use of a prepaid merchant card for the current purchase. The prompt may also provide information to a customer using a prepaid merchant card about similar alternative items having discounts greater than the items currently selected for purchase.

In one embodiment, the method provides information about items available that are complementary to the items currently selected for purchase. For example, alerting a consumer of required battery size and quantity for a battery-powered article being purchased.

The method also may provide information to a customer regarding the restrictions on any of said discounts and promotions.

The method also may provide information regarding more than one discount and promotion whereby said information is sorted from highest to lowest value to the customer.

Also, in one embodiment, the method includes a database that comprises;
a. value of a prepaid merchant card;
b. information on discounts and promotions;
c. information on discounts provided to a prepaid merchant card.

In one embodiment, the method includes information on a consumer. The information may be any or all of information on purchase history and product preferences. The information is used to generate discounts and promotions based on purchase history and product preferences of a particular consumer.

In one embodiment, the method also provides remote access to said information about discounts and promotions available to users of said prepaid merchant card is through telephone, Internet, cell phone, text message or combinations thereof. The merchant may remotely contact a consumer. Alternatively, the consumer may access information about discounts and promotions. The information may be selectively available based on a promotion period. The access may be initiated by the merchant or consumer.

### BRIEF DESCRIPTION OF THE DRAWINGS

FIGS. 1-5 are a single sequential flow chart outlining a preferred embodiment of the invention.

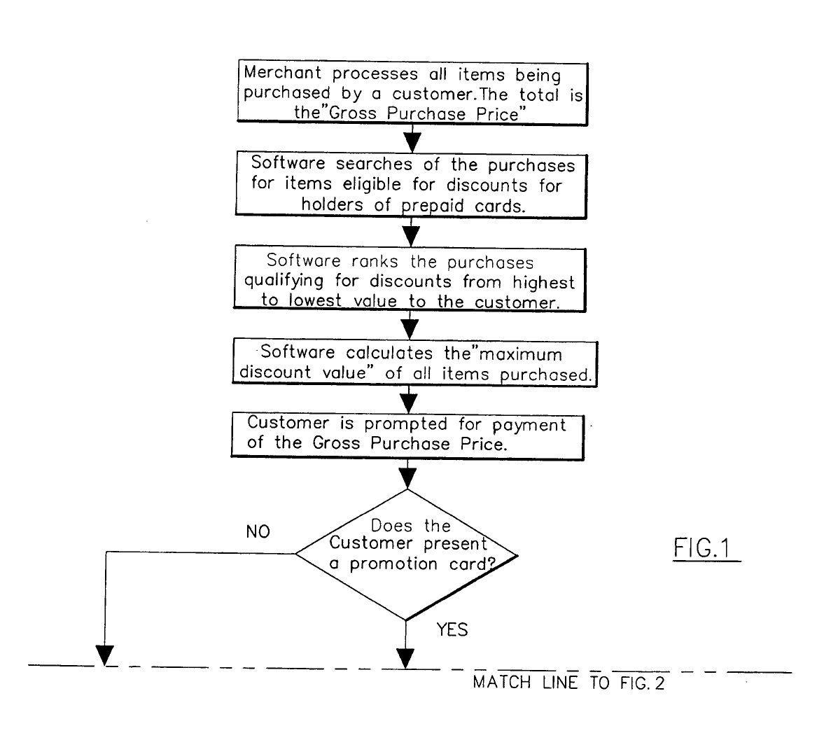

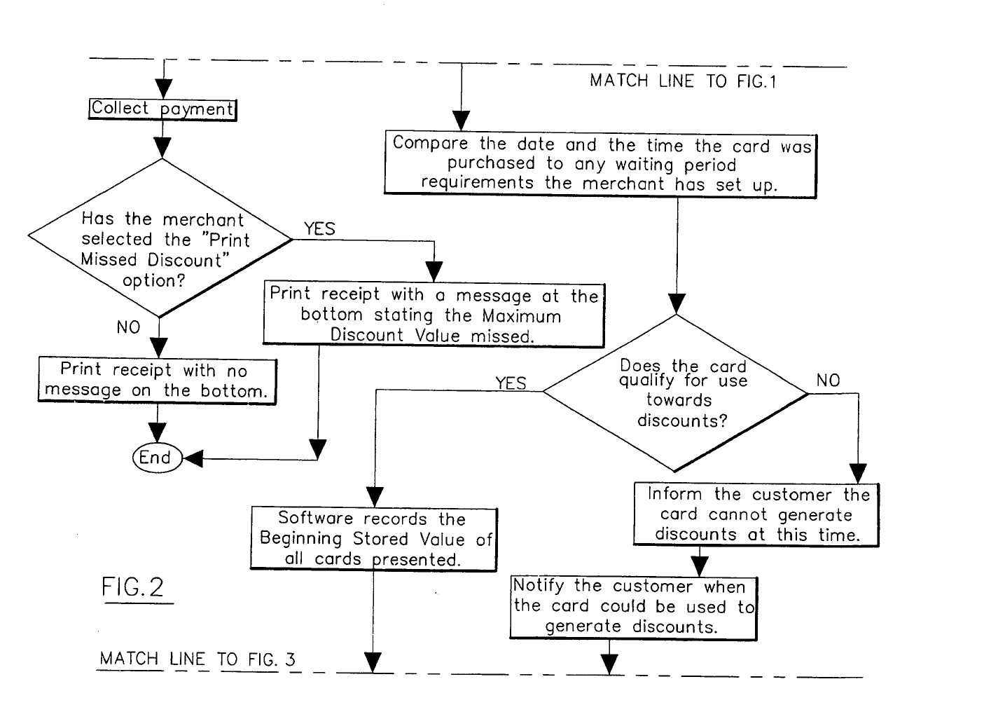

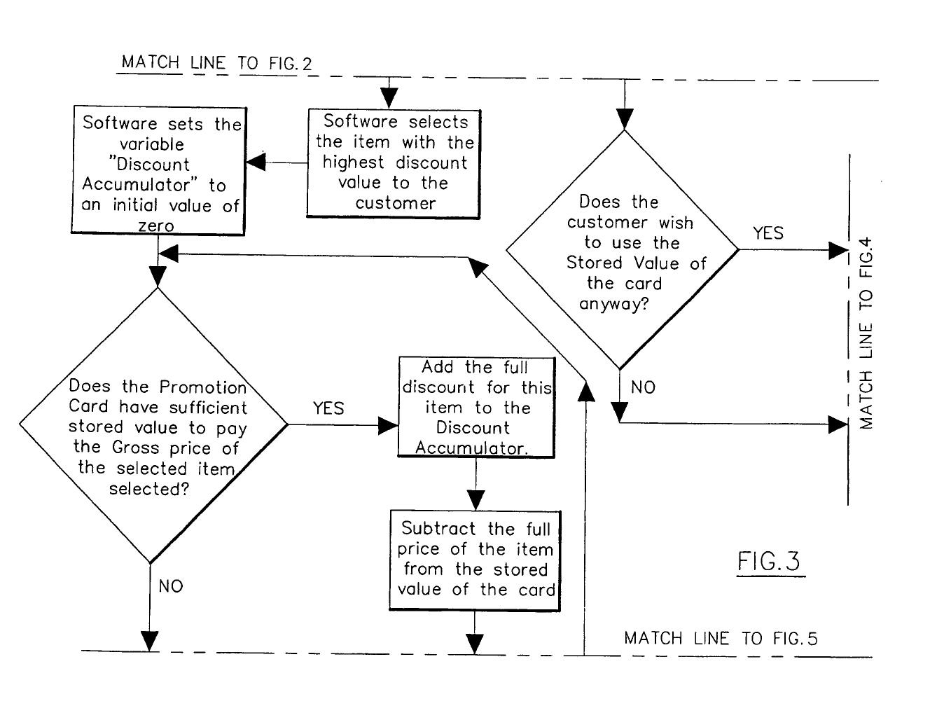

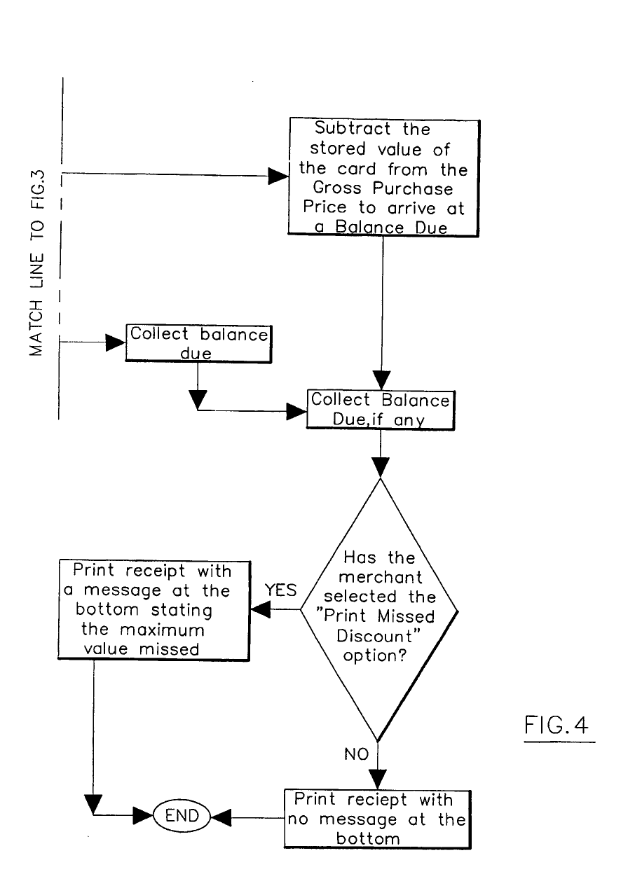

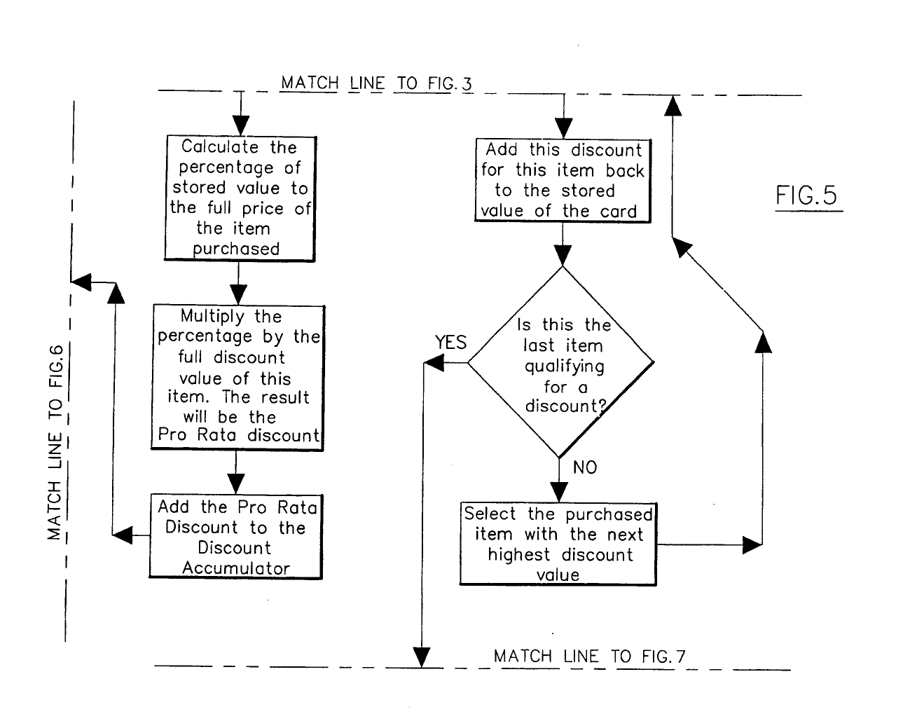

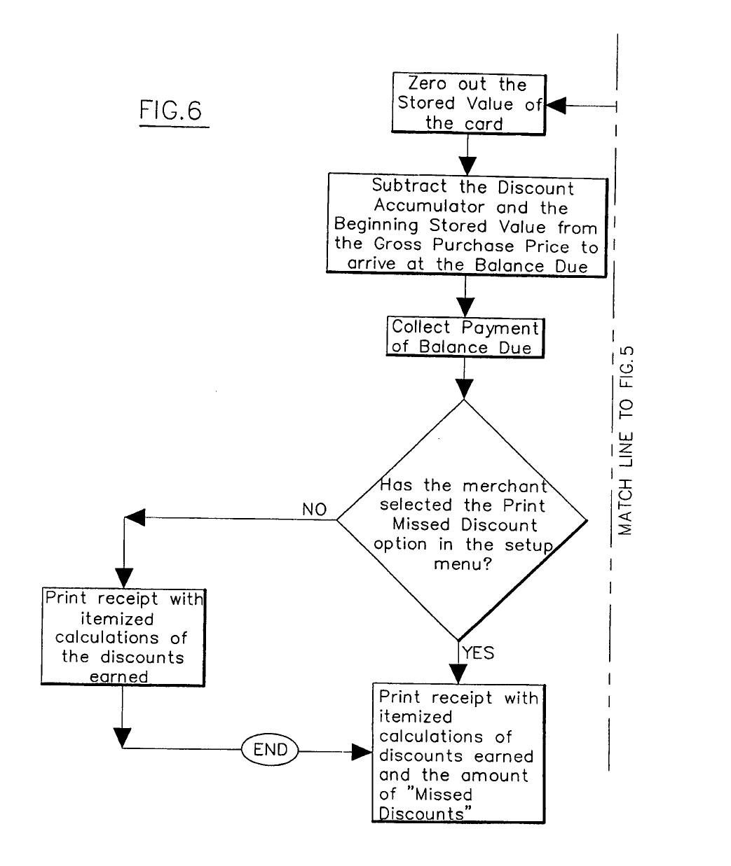

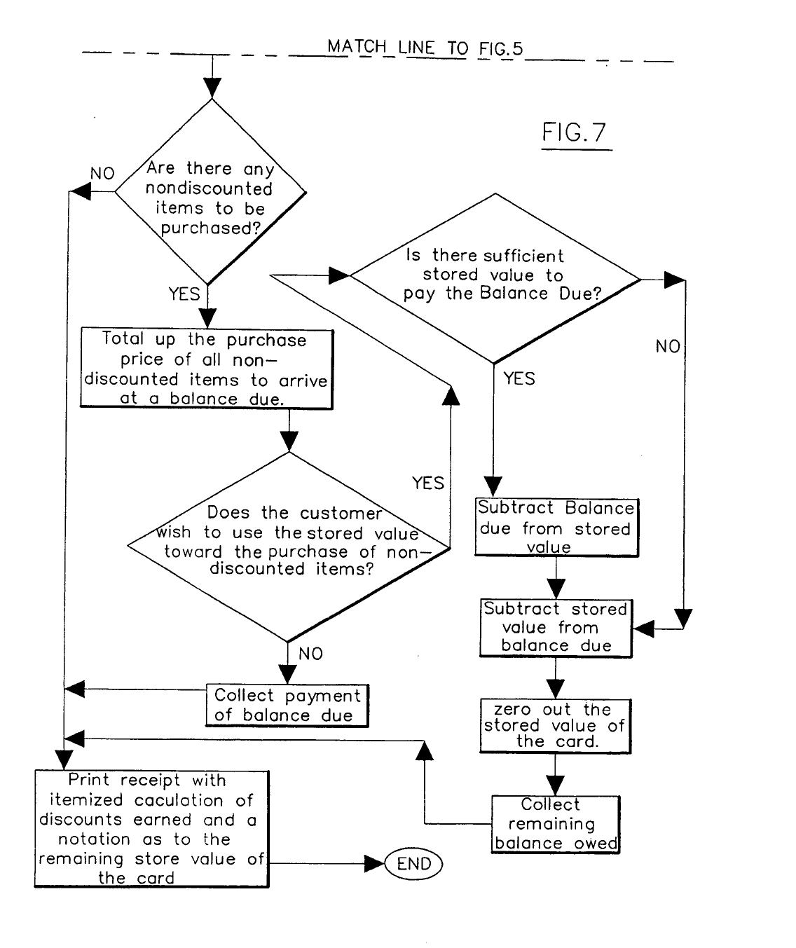

### DETAILED DESCRIPTION OF THE PREFERRED EMBODIMENTS

Software enables the merchant to select items, services, time periods or locations it wishes to promote. The software also allows the merchant to set the beginning and ending time for each promotion and the value of each promotion. Another set up item would be the option of printing various messages on the bottom of the receipt that state how much the customer saved by utilizing the Card or how much savings was missed because the customer did not utilize a Card or if the stored value of the Card was insufficient to pay for the promoted items or services. The merchant establishes the waiting period before the Card would be eligible for the promotion value of the items purchased.

In one embodiment, merchants may impose a waiting period to discourage a consumer from purchasing a prepaid card and immediately redeeming it; thereby destroying the cash flow benefit to the merchant. However, it is contemplated that the card would always be redeemable for its stored value regardless if the merchant decides to impose a waiting period for when the card could be used to take advantage of promotions.

In one preferred embodiment. the customer brings purchases to the register and the merchant processes all items and services purchased as usual. After all items are processed, the software would search for all items eligible for promotions tied to prepaid cards. The Maximum Discount Value of all items purchased would be calculated and stored by the software at this time. This enables the merchant to display a message on the receipt about the amount of money saved or the amount of discounts forfeited because the customer either did not pay with a prepaid card or the prepaid card did not have sufficient stored value. The merchant would have the option of printing this on the receipt based on his belief that such a message would encourage the purchase of prepaid cards or irritate the consumer.

If the customer has not already presented a Card(s) the cashier would ask the customer if he has any to present. The software would verify that each card has passed the waiting period the merchant has imposed. The stored value of each eligible card presented would be totaled. The software would then rank the promotional items purchased from highest to lowest value to the customer. This ranking is advantageous in case the customer does not have enough stored value to purchase all of the promotional items. If the stored value of the card is not sufficient to take advantage of all of the promotional discounts, the stored value is preferrably applied to the items that provide the most value to the consumer.

The software would continue to apply the stored value of the card to the promotional items, from greatest to least value, until the stored value is depleted or the promotional items are all subtracted from the stored value. One by one the purchase transaction of each promotional item is completed by adding the discount associated with that item to a programming variable called a Discount Accumulator. Simultaneously the non discounted purchase price would be subtracted from the Stored Value. If the card only has sufficient stored value to partially pay for a promotional item it would generate a pro rata discount. The pro rata discount would also be added to the Discount Accumulator and the stored value of the card would be zeroed out.

Once either the stored value is depleted or all of the promotional items have been accounted for the total of the Discount Accumulator will be subtracted from the Gross Purchase Price of all items and a Balance Due will be displayed. If the card still has stored value after all promotional items have been deducted the customer would be prompted to see if he would like the remaining stored value applied to the Balance Due. There is good reason for this request as the customer might want to preserve the remaining stored value to take advantage of future promotions and the merchant would like to continue to take advantage of the cash flow.

If the customer chooses to use the Card for the Balance Due, the total of the non promotional items would be subtracted from the stored value. If the card does not have sufficient value to pay for these items the customer would be prompted for alternate forms of payment to complete the purchase. If the customer chooses to only use the card for promotional items he is welcome to do so. He would simply complete the purchase with an alternate form of payment.

Upon completion of the purchase a receipt would be printed that would show the stored value of the card(s) at the beginning of the transaction, the calculation of each discount and the associated amount of stored value consumed by that item. The receipt would conclude with the amount of stored value at the end of the transaction. The amount of the discount earned would appear directly underneath the promotional item so that if the item is returned at a later date the merchant only refunds the net amount paid for the item. At the merchant's option the receipt may also print out the grand total of all discounts earned and/or the total of all discounts missed.

Suitable software is required for the setup of the merchant's preferences, the loading of the stored value of the cards, handling the actual customer purchase and handling customer returns. Writing such software is well known to those skilled in the art and consequently is not described in detail herein.

The software may include, but would not be limited to any or all of
a. A means for loading stored value into a prepaid merchant card;
b. A means for the merchant to enter promotions, including start and end dates;
c. A means for the merchant to enter waiting periods and other rules and restrictions he deems necessary;
d. A means for checking if the prepaid card is eligible to be used to take advantage of discounts;
e. A means for totaling all purchases and calculating eligible discounts.
f. A means for sorting the items eligible for discount from highest to lowest value to the customer;
g. A means for prompting the customer if he has any prepaid cards he cares to redeem;
h. A means for methodically applying the stored value of the card toward the purchase of items in descending value to the customer;
i. A means for calculating the pro rata discount earned when there is not sufficient stored value to pay for the entire purchase of the item.
j. A means for accumulating the discounts earned;
k. A means for subtracting the discounts earned and the stored value utilized to purchase the promotional items from the total purchase price of all items purchased;
l. A means for prompting the customer if he chooses to utilize the card toward the purchase of items that are not eligible for discounts.
m. A means of collecting alternate forms of payment in the event the customer does not have sufficient stored value to pay for the entire purchase;
n. A means for printing a receipt which displays the calculation of discounts earned;
o. A means for printing the total value of discounts earned as well as missed discounts;
p. A means for processing customer returns wherein the merchant only refunds the net amount paid by the customer.

Although the invention has been described with reference to specific embodiments, the description is intended to be illustrative of the invention and is not intended to be limiting. Various modifications and applications may occur to those skilled in the art without departing from the true spirit and scope of the invention as defined in the appended claims.

I claim:

1. A method for improving the cash flow of a merchant and directing customer buying decisions comprising the steps of:
a. providing a customer with a prepaid merchant card;
b. providing information to a database about discounts and promotions available to users of said prepaid merchant card; and
c. providing a customer access to said information about discounts and promotions available to users of said prepaid merchant card.

2. The method of claim 1 further providing a prompt to a customer at check out regarding use of a prepaid merchant card for the current purchase.

3. The method of claim 1 further providing information to a customer using a prepaid merchant card about similar alternative items having discounts greater than the items currently selected for purchase.

4. The method of claim 1 further providing information about items available that are complementary to the items currently selected for purchase.

5. The method of claim 1 further providing information to a customer regarding the restrictions on any of said discounts and promotions.

6. The method of claim 1 further providing information regarding more than one discount and promotion whereby said information is sorted from highest to lowest value to the customer.

7. The method of claim 1 where said database comprises;
a. value of a prepaid merchant card;
b. information on discounts and promotions;
c. information on discounts provided to a prepaid merchant card.

8. The method of claim 7 further comprising information on a consumer.

9. The method of claim 8 where said information on a consumer comprises information on purchase history and product preferences.

10. The method of claim 9 where said information on a consumer is used to generate discounts and promotions based on purchase history and product preferences of a particular consumer.

11. The method of claim 1 wherein said access to said information about discounts and promotions available to users of said prepaid merchant card is through telephone, Internet, cell phone, text message or combinations thereof.
